(19) United States
(12) Patent Application Publication
(10) Pub. No.: US 2004/0013204 A1
(43) Pub. Date: Jan. 22, 2004

(54) Method and apparatus to compensate imbalance of demodulator

(76) Inventor: Nati Dinur, Omer (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/195,312

(22) Filed: Jul. 16, 2002

(51) Int. Cl. H04L 5/12

(52) U.S. Cl. 375/261; 375/140

(57) ABSTRACT

Briefly, a method and apparatus to compensate for an imbalance of a demodulator by providing calibration parameters to a calibration network is provided. The apparatus may include a calibration network that may output an in-phase signal and a quadrature signal and a processor to generate calibration parameters. The processor may generate the calibration parameters by measuring an average power of the in-phase signal, an average power of the quadrature signal; and a correlation between the in-phase signal to the quadrature signal.

### BACKGROUND OF THE INVENTION

Demodulators may be used in receivers to demodulate an input signal that may comprise data and voice to baseband signals, for example an in-phase (I) and a quadrature (Q) signal. An example of a demodulator that provides IQ signals may be a quadrature demodulator. The quadrature demodulator may receive a modulated radio frequency (RF) signal and provide I and Q signals. However, various factors related to the physical structure of the demodulator, such as for example, filters, local oscillator, phase shifters and the like, may cause the demodulator to produce I and Q signals which are imbalanced. An analog signal may be generated from a combination of the I and Q signals and may include voice and/or data. The imbalance between the I and Q signals may produce a distorted analog signal.

Thus, there is a need for better ways to provide balanced I and Q signals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block diagram of a transceiver, according to an embodiment of the present invention;

FIG. 2 is a schematic illustration of a calibration network helpful in understanding some embodiments of the present invention; and

FIG. 3 is a flowchart of a method according to the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

It should be understood that the present invention may be used in variety of applications. Although the present invention is not limited in this respect, the circuits and techniques disclosed herein may be used in many apparatuses such as receivers of a radio system. Receivers intended to be included within the scope of the present invention include, by a way of example only, wireless local area network (LAN) receivers, two-way radio receivers, digital system receivers, analog system receivers, cellular radiotelephone receivers and a like.

Type of wireless LAN receivers intended to be within the scope of the present invention include, although not limited to, receivers for receiving spread spectrum signals such as for example, Frequency Hopping Spread Spectrum (FHSS), Direct Sequence Spread Spectrum (DSSS) and the like.

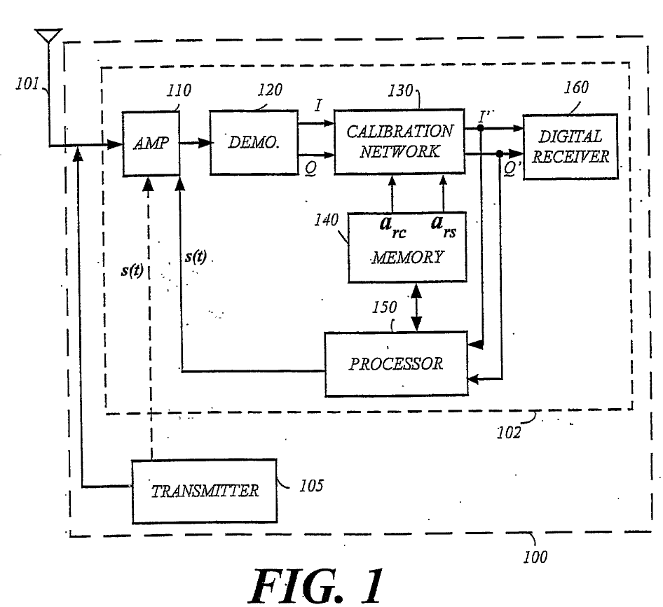

Turning to FIG. 1, a transceiver 100 in accordance with an embodiment of the invention is shown. The transceiver 100 may comprise an antenna 101, a receiver 102 and a transmitter 105. Although the scope of the present invention is not limited to this example, receiver 102 may include an amplifier 110, a demodulator 120, a calibration network 130, a memory 140, a processor 150 and a digital receiver module 160.

Although the scope of the present invention is not limited in this respect, the transceiver 100 may be for example, a wireless LAN transceiver that may receive and/or transmit FHSS and/or DSSS signals through antenna 101. However, it should be understood that other type of transceivers able to transmit other types of signals, for example, analog signals, amplitude modulated signals, frequency modulated signals, time division multiple access (TDMA) signals and the like, may be used with some embodiments of the present invention.

Although the scope of the present invention is not limited to this embodiment, transceiver 100 may have two operation modes. In the first operation mode, transceiver 100 may transmit and receive signals. For example, transceiver 100 may transmit and receive signals over a wireless LAN network, if desired. However, it should be understood that for the simplicity and the clarity of the description, only the operation of receiver 102 will be described. In the first operation mode, amplifier 110 may receive a signal from antenna 101. Amplifier 110 may amplify the received signal and output it to demodulator 120. Demodulator 120 may be for example, a quadrature demodulator, a direct conversion demodulator and the like. Furthermore, demodulator 120 may demodulate the received signal and output I and Q signals.

In addition, the I and Q signals may be calibrated by calibration network 130. Calibration network 130 may compensate for demodulator 120 impairments. Although the scope of the present invention is not limited in this respect, demodulator impairments may include imbalance in phase and imbalance in amplitude between I and Q signals and the like. Furthermore, calibration network 130 may compensate for demodulator 120 impairments by manipulating the calibration parameters.

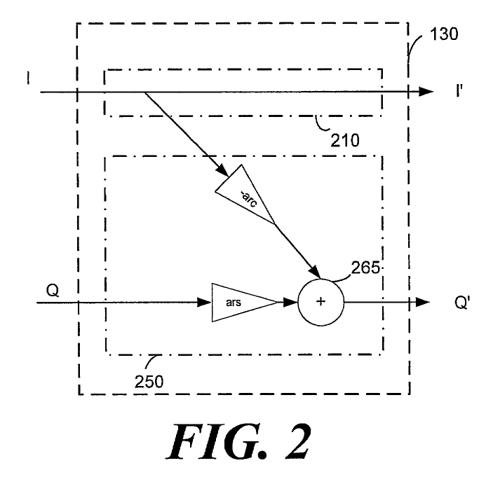

In addition, calibration network 130 may provide compensated I′, Q′ signals to digital receiver module 160. Digital receiver module 160 may decode data and/or voice from the compensated I′, Q′ signals, if desired. A detailed description of calibration network 130 with reference to FIG. 2 will be given hereinbelow.

Although the scope of the present invention is not limited in this respect, in the second operation mode, which may be described as a calibration mode of the receiver 102, processor 150 may generate a test signal s(t). For example, test signal s(t) may be a noisy signal, a natural noise signal and the like. Furthermore, in another embodiment of the present invention, test signal s(t) may be provided by transmitter 105 to amplifier 110 (shown with a dotted line), if desired. Thus, an amplified test signal may be inputted to demodulator 120. Demodulator 120 may demodulate the test signal s(t) and may provide I and Q signals. Although the scope of the present is not limited in this respect, calibration network 130 may include calibration parameters such as for example, aᵣₛ and a_{rc}, wherein a_{rc} may compensate for a phase imbalance and aᵣₛ may compensate for an amplitude imbalance, although the scope of the present invention is in no way limited in this respect.

Furthermore, in one embodiment of the present invention, calibration parameters aᵣₛ and a_{rc} may be provided by memory 140 to calibration network 130. Although the scope of the present invention is not limited in this respect, memory 140 may be for example, a shift register, a flip flop, a Flash memory, a read access memory (RAM), dynamic RAM (DRAM), static RAM (SRAM) and the like. Furthermore, processor 150 may generate and/or store calibration parameters values in memory 140.

Although the scope of the present invention is not limited in that respect, processor 150 may start the calibration processes by setting an initial value to calibration parameters aᵣₛ and a_{rc}. For example, the initial values may be aᵣₛ=1, a_{rc} =0. In addition, processor 150 may remove the DC component of the I and the Q signals prior to making the measurements, or may use other equivalent methods for removing the DC component. Furthermore, processor 150 may generate calibration parameters by measuring an average power of I′, an average power of Q′; and a correlation between the I′ signal and the Q′ signal and may vary the values of calibration parameters aᵣₛ and a_{rc} until the average power of I′ and the average power of Q′ signals converge to substantially the same value. An example for this calculation may be described by ΣI′²=ΣQ′². In addition, processor 150 may vary the values of calibration parameters aᵣₛ and a_{rc} until a product of I′Q′ converges to substantially zero. It should be understood to one skilled in the art that in some embodiments of the present invention, processor 150 may vary the values of calibration parameters either by selecting values stored in memory 140 or by operating the following method, although it should be understood that the present invention is not limited in this respect:

1. removing DC components from I′ and Q′ signals;

2. measuring the average power of I′ signal by calculating, for example, the sum of I′*I′ that may be expressed with ΣI′*I′

3. measuring the average power of Q′ signal by calculating, for example, the sum of Q′*Q′ which may be expressed with ΣQ′*Q′;

4. measuring a correlation between I′ and Q′ by calculating, for example, the sum of I′*Q′ which may be expressed with ΣI′*Q′; and

5. calculating the values of calibration parameters aᵣₛ and a_{rc} according to the following equations, if desired:

$$\begin{matrix}{a}_{rc} = \frac{\sum I * Q}{\sqrt{\sum {I}^{2} * \sum {Q}^{2} - {( \sum I * Q )}^{2}}} ; \\ {a}_{rs} = \frac{\sum {I}^{2}}{\sqrt{\sum {I}^{2} * \sum {Q}^{2} - {( \sum I * Q )}^{2}}} .\end{matrix}$$

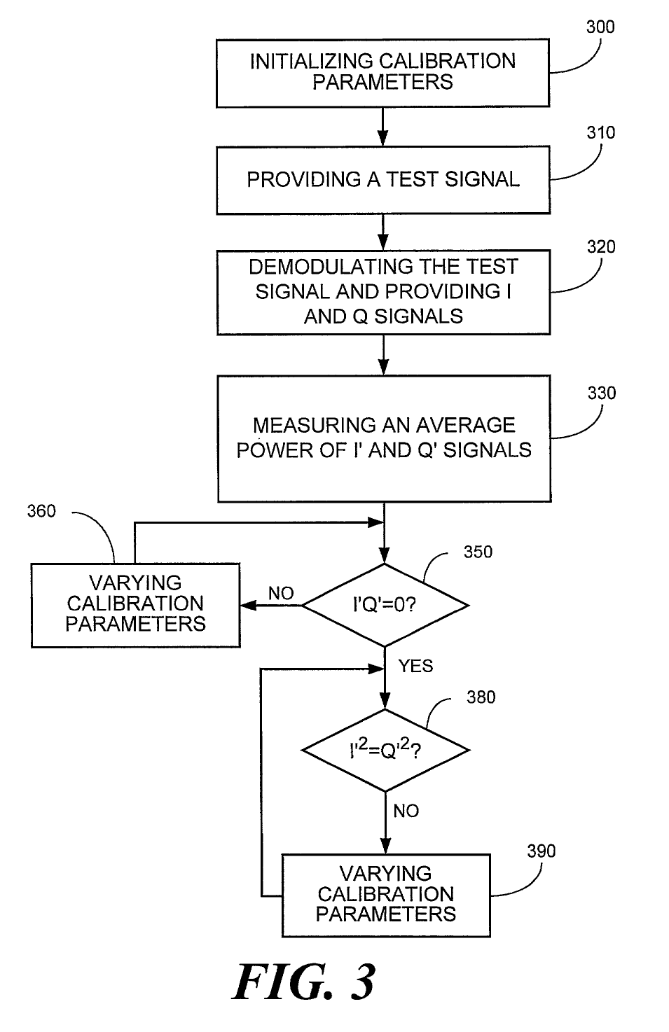

Although the scope of the present invention is not limited in this respect, processor 150 may be a digital signal processor (DSP), a reduced instruction set computer (RISC) processor, a microprocessor, a micro-controller, a custom integrated circuit to perform a predefined algorithm and/or method and the like. Furthermore, processor 150 may use methods and/or algorithms to generate the calibration parameters. Detailed examples of such algorithms will be provided with reference to FIG. 3.

Turning now to FIG. 2, a calibration network 130 according to some embodiments of the present invention is shown. Although the scope of the present invention is not limited in this respect, calibration network 130 may include an in-phase (I) module 210 and a quadrature (Q) module 250. More particularly, in this example, I module 210 may not include calibration parameters and Q module 250 may include an adder 265 and calibration parameters aᵣₛ and a_{rc}. For example, in one embodiment of the present invention, calibration parameters aᵣₛ and a_{rc} may compensate for an imbalance of amplitude and phase between the I signal and the Q signal outputted from demodulator 120, if desired.

In operation, I module 210 may receive the I signal and output the I′ signal. In this example the signal that is marked as I and/or I′ may refer to the I signal which is outputted from demodulator 120. In addition, Q module 250 may manipulate the I and Q signals with calibration parameters aᵣₛ and a_{rc}, to provide a Q′ signal that is substantially equal to the I signal. For example, the difference in amplitude between the I signal and the Q′ signal may be more than 1%. In addition, adder 265 may add the manipulation result of calibration parameters aᵣₛ and a_{rc} with the I and Q signals, respectively, to provide Q′ signal. However, in alternative embodiments of the present invention other calibration networks may be used, if desired. For example, in an alternative calibration network, calibration parameters aᵣₛ and a_{rc} may be included in I module 210. However, it should be understood to one skilled in the art that embodiments of the present invention are in no way limited to the calibration networks described above and a different calibration network may be used with embodiments of the present invention.

Turning to FIG. 3, a flow chart of a method of compensating an imbalance of demodulator 120 is shown. Although the scope of the present invention is not limited in this respect, the method may start with initializing the calibration parameters, for example, a_{rc}=0,aᵣₛ=1 (block 300) and with providing a test signal s(t) (block 310). As mentioned above, the test signal s(t) may be provided, in one embodiment of the present invention, by processor 150 and in other embodiments by transmitter 105. Furthermore, in some embodiments of the present invention, the test signal may be a natural noise signal of receiver 102. Furthermore, the test signal s(t) may be demodulated by demodulator 120. Demodulator 120 may output demodulated signals I and Q (block 320). Processor 150 may measure an average power of the in-phase signal and an average power of the quadrature signal (block 330). In addition, processor 150 may measure the correlation between I′ signal and Q′ and perform tests on the average values of I′ and Q′ signals. The first test may be to check the average of the product of I′Q′ (block 350). If the product of I′Q′ is different from zero, processor 150 may vary the values of aᵣₛ and a_{rc} until the product value converges to substantially zero (block 360). The second test may be to check if the average power values of the I′ and Q′ signals provided by calibration network 130 are substantially equal (block 380). In addition, processor 150 may vary the values of aᵣₛ and a_{rc} until average values of I′² and Q′² converge to substantially the same values (block 390).

while certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
a calibration network to output an in-phase signal and a quadrature signal; and
a processor to generate calibration parameters by measuring an average power of the in-phase signal, an average power of the quadrature signal and a correlation between the in-phase signal and the quadrature signal and to vary the calibration parameters until the in-phase signal and the quadrature signal converge to the substantially same value.

2. The apparatus of claim 1, wherein the processor is further able to vary one or more of the calibration parameters until a product of the in-phase signal with the quadrature signal converges to substantially zero.

3. The apparatus of claim 1, wherein the calibration network is able to compensate for impairments of the demodulator by manipulating the calibration parameters.

4. The apparatus of claim 1, wherein the demodulator comprises a quadrature demodulator.

5. The apparatus of claim 1 further comprising:
a transmitter to provide a modulated test signal to the demodulator.

6. A method comprising:
generating calibration parameters by measuring an average power of an in-phase signal, an average power of a quadrature signal and a correlation between the in-phase signal and the quadrature signal.

7. The method of claim 6, further comprising:
varying one or more of the calibration parameters until a product of the in-phase signal and the quadrature signal converges to substantially zero.

8. The method of claim 6, further comprising:
varying one or more of the calibration parameters until a power of the in-phase signal and a power of the quadrature signal converge to substantially the same value.

9. The method of claim 6, further comprising:
generating the in-phase signal and the quadrature signal by demodulating a modulated test signal.

10. The method of claim 6, wherein measuring further comprising:
averaging the in-phase signal;
averaging the quadrature signal; and
correlating between the in-phase signal and the quadrature signal.

11. An apparatus comprising:
a calibration network to output an in-phase signal and a quadrature signal;
a processor to generate calibration parameters by measuring an average power of the in-phase signal, an average power of the quadrature signal and a correlation between the in-phase signal and the quadrature signal and to vary one or more of the calibration parameters until the in-phase signal and the quadrature signal converge to the substantially same value; and
a direct sequence spread spectrum transmitter to provide a test signal to the calibration network.

12. The apparatus of claim 11, wherein the processor is further able to vary the calibration parameters until a product of the in-phase signal with the quadrature signal converges to substantially zero.

13. The apparatus of claim 11, wherein the calibration network is able to compensate for impairments of the demodulator by manipulating the calibration parameters.

14. The apparatus of claim 11, wherein the demodulator comprises a quadrature demodulator.

15. The apparatus of claim 11, wherein said transmitter is able to provide said test signal to the demodulator.

16. An article comprising a storage medium having stored thereon instructions that when executed result in:
generating calibration parameters by measuring an average power of an in-phase signal, an average power of quadrature signal; and a correlation between the in-phase signal to the quadrature signal.

17. The article of claim 16, wherein the instructions when executed further result in:
varying one or more of the calibration parameters until a product of the compensated in-phase signal and the compensated quadrature signal converges to substantially zero.

18. The article of claim 16, wherein the instructions when executed further result in:
varying one or more of the calibration parameters until a power of the in-phase signal and a power of the quadrature signal converge to substantially the same value.

19. The article of claim 16, wherein the instructions when executed further result in:
generating the in-phase signal and the quadrature signal by demodulating a modulated test signal.

20. The article of claim 16, wherein the instructions of measuring when executed further result in:
averaging the in-phase signal;
averaging the quadrature signal; and
correlating between the in-phase signal and the quadrature signal.
